(19) United States
(12) Patent Application Publication
(10) Pub. No.: US 2005/0041953 A1
(43) Pub. Date: Feb. 24, 2005

(54) IMAGE EDITING DEVICE FOR EDITING IMAGES CAPTURED BY A PHONE CAMERA

(76) Inventor: Jui-Hsiang Lo, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/605,657

(22) Filed: Oct. 16, 2003

(30) Foreign Application Priority Data
Aug. 18, 2003 (TW) 092122662

(51) Int. Cl. H04N 5/225

(52) U.S. Cl. 386/52

(57) ABSTRACT

An image editing device for editing image data captured by a phone camera. The image editing device is connected to the phone camera and a mobile phone. The phone camera comprises a connecting port, and the mobile phone comprises a connecting port. The image editing device comprises a receiving module for connecting to the connecting port of the phone camera and receiving data from the phone camera, an editing module for editing data received by the receiving module, a memory for storing data, a control module for controlling the image editing device, and an outputting module for connecting the connecting port of the mobile phone and outputting data edited by the editing module to the mobile phone.

### BACKGROUND OF INVENTION

1. Field of the Invention

The present invention relates to an image editing device, and more specifically, to an image editing devicefor editing image data captured by a phone camera.

2. Description of the Prior Art

Nowadays mobile phones have become very popular because of the decreasing price and the improvement of technology. So more and more mobile phones enter the market. Manufacturers also add more additional features and functions in their mobile phones to satisfy all kinds of consumers, like sending personal words and images to another mobile phone, browsing the internet, receiving and sending email, listening to the radio, and even providing image capturing function by an internal or external phone camera and sending photos by MMS.

However the prior art the conventional phone camera only provides the functions of capturing and sending the captured image, and cannot provide the additional editing functions for captured images. That is, the conventional phone camera often uses the DSC IC, which does not provide image-editing and special effect functions. So the image captured by the phone camera is limited to its original picture instead of being edited with such things as a frame or words on the original image. And it also reduces the fun of the MMS service.

### SUMMARY OF INVENTION

It is therefore a primary objective of the present invention to provide an image editing device for editing image data captured by a phone camera to solve the problems mentioned above.

Briefly summarized, an image editing device for editing image data captured by a phone camera is proposed. The image editing device is connected to the phone camera and a mobile phone. The phone camera comprises a housing, and a connecting port installed on the housing, and the mobile phone comprises a housing, and a connecting port installed on the housing of the mobile phone. The image editing device comprises a housing, a receiving module installed inside the housing of the image editing device for connecting to the connecting port of the phone camera and receiving data from the phone camera, an editing module installed inside the housing of the image editing device for editing data received by the receiving module, a memory installed inside the housing of the image editing device for storing data, a control module installed inside the housing of the image editing device for controlling the image editing device; and an outputting module installed inside the housing of the image editing device for connecting the connecting port of the mobile phone and outputting data edited by the editing module to the mobile phone.

Briefly summarized, amethod for editing image data captured by a phone camera is proposed, wherein the phone camera comprises a housing and a connecting port installed on the housing of the phone camera. The method comprises providing an image editing device, transmitting data received captured by the phone camera to the image editing device, editing the data captured by the phone camera by the image editing device, and transmitting the data edited by the image editing device to a mobile phone.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of an image editing device connected to a mobile phone and a phone camera according to the present invention.

FIG. 2 is a block diagram of the image editing device connected to other devices.

FIG. 3 is a block diagram of the image editing device.

FIG. 4 contains a flowchart illustratingactions taken by the image editing device to edit the image data captured by the phone camera according to the present invention.

### DETAILED DESCRIPTION

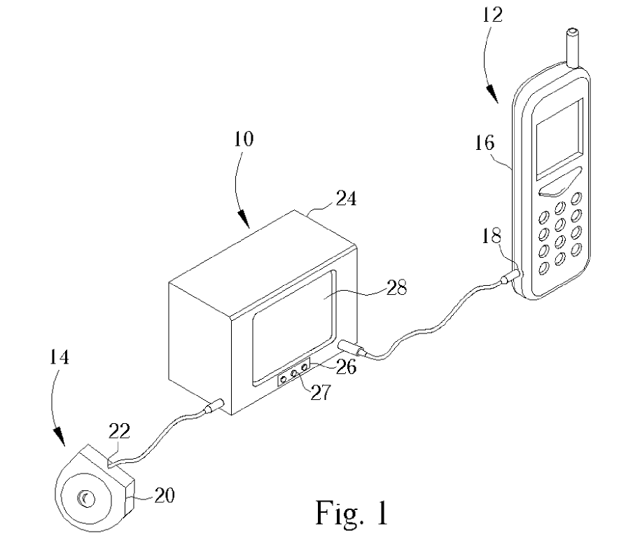

Please refer to FIG. 1. FIG. 1 is a diagram of an image editing device 10 connected to a mobile phone 12 and a phone camera 14 according to the present invention. The mobile phone 12 includes a housing 16 and a connecting port 18 installed on the housing 16 on the mobile phone 12. The phone camera 14 includes a housing 20 and a connecting port 22 installed on the housing 20 on the phone camera 14. The image editing device 10 is connected to the mobile phone 12 via the connecting port 18 of the mobile phone 12 and connected to the phone camera 14 via the connecting port 22 of the phone camera 14. The image editing device 10 includes a housing 24, and a plurality of control buttons 26 installed on the housing 24 of the image editing device 10, with which users can input a control signal to edit an image with the control buttons 26. The control buttons includes a hot key 27 for activating the special effect program, like the framing function. The image editing device 10 further includes a touch panel 28 installed on the housing 24 of the image editing device 10, which users can input a control signal to edit an image with the touch panel 28.

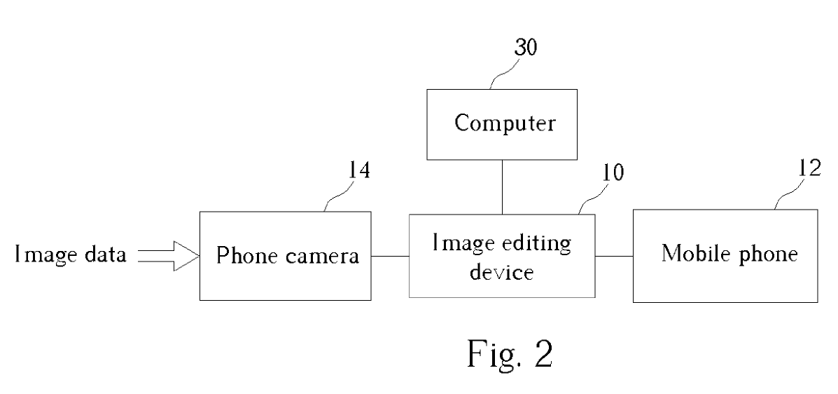

Please refer to FIG. 2. FIG. 2 is a block diagram of the image editing device 10 connected to other devices. The phone camera can capture an image and then transmit the image to the image editing device 10 for editing the image or adding special effectsto the image. Afterwards the image edited by the image editing device 10 is transmitted to the mobile phone 12. In addition, the image editing device 10 can be connected to a computer 30 and transmit data with the computer 30. So the image editing device 10 can transmit data from the mobile phone 14 to the computer 30 or receive data form the computer 30.

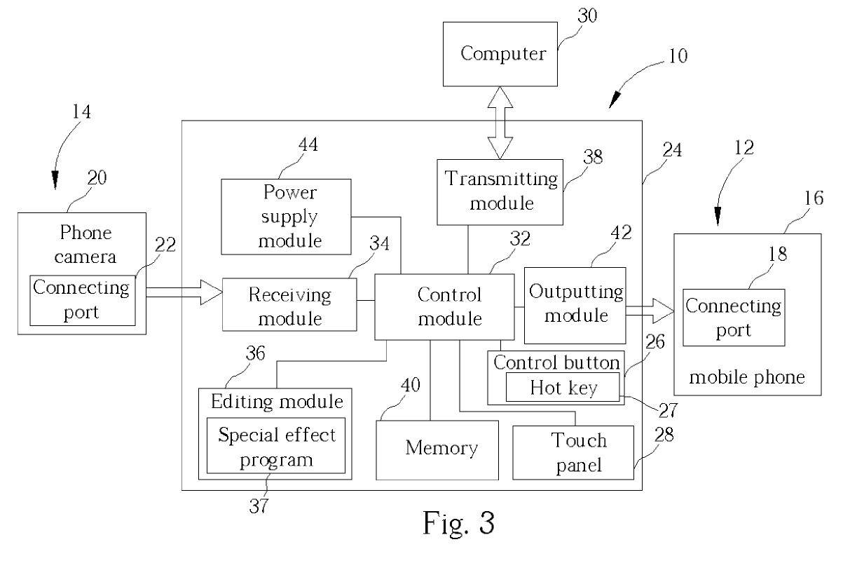

Please refer to FIG. 3. FIG. 3 is a block diagram of the image editing device 10. The image editing device 10 includes a control module32 installed inside the housing 24 of the image editing device 10 for controlling the image editing device 10, a receiving module 34 installed inside the housing 24 of the image editing device 10 for connecting to the connecting port 22 on the housing 20 of the phone camera 14 and receiving data from the phone camera 14, and an editing module 36 installed inside the housing 24 of the image editing device 10 for editing or adding the special effectsto image data received by the receiving module 34. The editing module 36 includes a special effect program 37 for providing the image special effects, like adding a frame on an image, atomizing an image, converting a color image into a monochrome image, and so on. The special effect program 37 can include images for assisting in the image special effects, like frame pictures, compound pictures, and so on. The image editing device 10 further includes a transmitting module 38 installed inside the housing 24 of the image editing device 10 and connected to the control module 32 for connecting the computer 30 and transmitting data with the computer 30. The transmitting module 38 can transmit data from the mobile phone 14 to the computer 30 or receive data form the computer 30. The image editing device 10 further includes a memory 40 installed inside the housing 24 of the image editing device 10 and connected to the control module 32 for storing data from the computer 30 or edited by the editing module 36, an outputting module 42 for connecting the connecting port 18 on the housing 16 of the mobile phone 12 and outputting data edited by the editing module 36 to the mobile phone 12, and a power supply module 44 installed inside the housing 24 of the image editing device 10 for receiving external electric power and supplying the electric power to the image editing device 10.

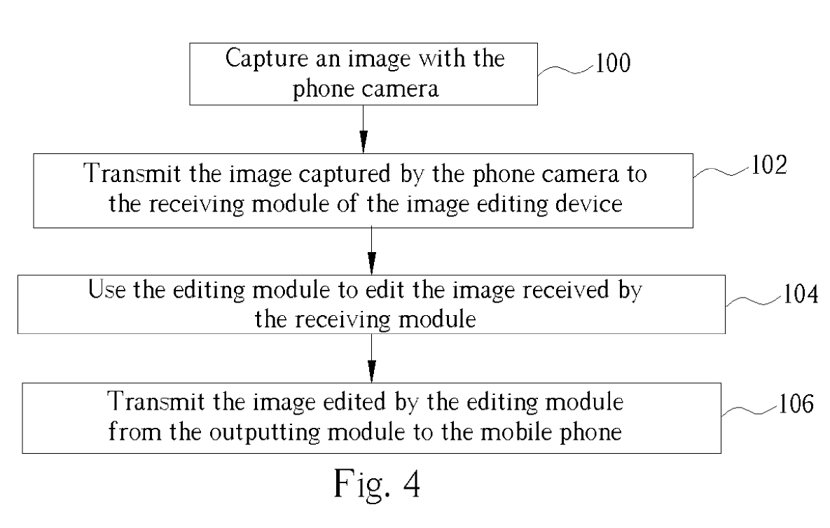

Please refer to FIG. 4.FIG. 4 contains a flowchart illustrating actions taken with the image editing device 10 to edit the image data captured by the phone camera 14 according to the present invention. The method includes:
Step 100: capture an image with the phone camera 14;
Step 102: transmit the image captured by the phone camera 14 from the connecting port 22 of the phone camera 14 to the receiving module 34 of the image editing device 10;
Step 104: use the editing module 36 of the image editing device 10 to edit the image received by the receiving module 34; and
Step 106: transmit the image edited by the editing module 36 of the image editing device 10 from the outputting module 42 to the connecting port 18 of the mobile phone 12.

The detailed description of the actions listed above is as follows. First users can use the mobile phone 12 to operate the phone camera 14 for capturing an image. Then the image captured by the phone camera 14 can be transmitted from the connecting port 22 of the phone camera 14 to the receiving module 34 of the image editing device 10. The transmission interface between the receiving module 34 and the connecting port 22 of the phone camera 14 can be a Pop-Port™ interface or other type interface. The image editing device 10 can not only receive data from the phone camera 14 by the receiving module 34, but also receive data from the computer 30 by the transmitting module 38. The transmitting module 38 can communicate with the computer in the Bluetooth wireless network protocol, in infrared technology, in USB interface, and so on. After the image editing device 10 receives the image mentioned above, users can use the control buttons 26, the hot key 27, or the touch panel 28 to input control signals for controlling the control module 32 to command the editing module 36 to edit the image or add the special effects to the image. The editing module 36 can provide image browsing, zooming in, zooming out, moving, rotating functions, and so on. And the special effects can provide hue adjustment, color adjustment, out of focus effects, mosaic effects, sticker effects, or adding a frame or words to the image. All editing functions and special effects can be included in the editing module 36.

The image edited by the editing module 36 can be stored in the memory 40 or transmitted to the outputting module 42 of the image editing device 10. The outputting module 42 can receive the data edited by the editing module 36 from the control module 32 or receive the data stored in the memory 40, and then output the data to the connecting port 18 of the mobile phone 12 for transmitting the image data to the mobile phone 12. The outputting module 42 of the image editing device 10 can be an RS-232 interface or other type interface. When the mobile phone 12 receives the editing image data, users can send the data to other people via the communication system such as MMS function or store the data in the memory of the mobile phone 12 to create a personal desktop or schematic item of the mobile phone 12.

The image editing device 10 can be a personal computer and connected to the phone camera 14 and the mobile phone 12 by cables. That is, users can transmit the image captured by the phone camera 14 to the personal computer, edit the image by the image processing software in the personal computer, and then transmit the edited image to the mobile phone 12 by cables. So users only have to purchase the cables for connecting the phone camera 14 and the personal computer and for connecting the mobile phone 12 and the personal computer, and the image processing software, and then they can edit the image captured by the phone camera 14 and transmit the image to the mobile phone 12. And in this way it only costs a little money and can achieve the image editing function. The transmission interface between the phone camera 14 and the personal computer can be any type of connectors, like the Pop-Port™, USB OTG interface, and so on. The phone camera 14 can communicate with the personal computer through a cable or a wireless communication, like Blue-tooth wireless network protocol or infrared technology. Similarly the transmission interface between the mobile phone 12 and the personal computer can be any type of connectors, like the Pop-Port™, USB OTG interface, and so on. The mobile phone 12 can communicate with the personal through a cable or a wireless communication, like Bluetooth wireless network protocol or infrared technology.

In contrast to the prior art, the present invention provides the image editing device 10 for editing or adding a special effect to the image captured by the phone camera 14. And it improves the defect of the external phone camera 14 only providing for the image capturing and transmission function. Furthermore the editing image in the mobile phone 12 can be sent to other people by MMS function of the mobile phone 12 or stored in the memory of the mobile phone 12 to create a personal desktop or schematic item of the mobile phone 12. So it is convenient for users to process the image captured by the phone camera 14. The image editing device 10 connected to the mobile phone 12 and the phone camera 14 can be designed for small size and carrying conveniently, and for editing the image captured by the phone camera 14 conveniently and increasing the fun of MMS service.

Those skilled in the art will readily observe that numerous modifications and alterations of the device may be made while retaining the teachings of the invention. Accordingly, the above disclosure should be construed as limited only by the metes and bounds of the appended claims.

1. An image editing device for editing image data captured by a phone camera, wherein the image editing device is connected to the phone camera and a mobile phone, the phone camera comprising a housing, and a connecting port installed on the housing, the mobile phone comprising a housing, and a connecting port installed on the housing of the mobile phone, the image editing device comprising:
a housing;
a receiving module installed inside the housing of the image editing device for connecting to the connecting port of the phone camera and receiving data from the phone camera;
an editing module installed inside the housing of the image editing device for editing data received by the receiving module;
a memory installed inside the housing of the image editing device for storing data;
a control module installed inside the housing of the image editing device for controlling the image editing device; and
an outputting module installed inside the housing of the image editing device for connecting to the connecting port of the mobile phone and outputting data edited by the editing module to the mobile phone.

2. The image editing device of claim 1 further comprising a transmitting module installed inside the housing of the image editing device for connecting to a computer and transmitting data with the computer.

3. The image editing device of claim 2 wherein the transmitting module communicates with the computer in the Bluetooth wireless network protocol.

4. The image editing device of claim 2 wherein the transmitting module communicates with the computer by infrared technology.

5. The image editing device of claim 2 wherein the transmitting module contains a USB interface.

6. The image editing device of claim 1 wherein the receiving module of the image editing device contains a Pop-Port ™ interface.

7. The image editing device of claim 1 wherein the outputting module of the image editing device contains a RS-232 interface.

8. The image editing device of claim 1 further comprising a plurality of control buttons installed on the housing of the image editing device for inputting a control signal.

9. The image editing device of claim 8 wherein the editing module further comprises a special effect program.

10. The image editing device of claim 9 wherein the plurality of control buttons comprise a hot key for activating the special effect program.

11. The image editing device of claim 1 further comprising a touch panel installed on the housing of the image editing device for inputting a control signal.

12. The image editing device of claim 1 further comprising a power supply module installed inside the housing of the image editing device for receiving external electric power and supplying the electric power to the image editing device.

13. A method for editing image data captured by a phone camera, wherein the phone camera comprises a housing and a connecting port installed on the housing of the phone camera, the method comprising:
(a)providing an image editing device;
(b)transmitting data received captured by the phone camera to the image editing device;
(c)editing the datacaptured by the phone camera with the image editing device; and
(d)transmitting the data edited by the image editing device to a mobile phone.

14. The method of claim 13 wherein the image editing device further comprises:
a housing;
a receiving module installed inside the housing of the image editing device for connecting to the connecting port of the phone camera and receiving data from the phone camera;
an editing module installed inside the housing of the image editing device for editing data received by the receiving module;
a memory installed inside the housing of the image editing device for storing data;
a control module installed inside the housing of the image editing device for controlling the image editing device; and
an outputting module for outputting data to the mobile phone.

15. The method of claim 14 wherein the receiving module of the image editing device contains a Pop-Port™ interface.

16. The method of claim 14 wherein the outputting module of the image editing device contains a RS-232 interface.

17. The method of claim 14 wherein the image editing device further comprises a plurality of control buttons installed on the housing of the image editing device for inputting a control signal.

18. The method of claim 14 wherein the image editing device further comprises a touch panel installed on the housing of the image editing device for inputting a control signal.

19. The method of claim 13 wherein the image editing device is a computer.

20. The method of claim 19 wherein the image editing device is connected to the phone camera and the mobile phone by cables.
